(19) United States
(12) Patent Application Publication
(10) Pub. No.: US 2015/0302011 A1
(43) Pub. Date: Oct. 22, 2015

(54) IMAGE MANAGEMENT DEVICE, IMAGE GENERATION PROGRAM, IMAGE MANAGEMENT METHOD, AND IMAGE MANAGEMENT PROGRAM

(71) Applicant: RAKUTEN, INC., Tokyo (JP)

(72) Inventor: Yukiko Ochiai, Shinagawa-ku (JP)

(73) Assignee: RAKUTEN, INC., Shinagawa-ku, Tokyo (JP)

(21) Appl. No.: 14/647,367

(22) PCT Filed: Dec. 26, 2012
(86) PCT No.: PCT/JP2012/083634

§ 371 Date: May 26, 2015

(51) Int. Cl. G06F 17/30; G06Q 30/06

(52) U.S. Cl. CPC G06F 17/3028; G06Q 30/0643; G06Q 30/0623

(57) ABSTRACT

The image management device according to one embodiment includes a receiving unit, a search unit, and a transmitting unit. The receiving unit receives an identifier of a user intending to publish an image set including a reference image on a network from a user terminal. The search unit specifies one or more products corresponding to the identifier by referring to a storage unit storing a product trading history of each user and extracts product images of the specified products. The transmitting unit transmits the one or more extracted product images as materials of the image set to the user terminal. The image set is generated by combining the reference image and at least some of the one or more product images.

### TECHNICAL FIELD

One aspect of the present invention relates to an image management device, an image generation program, an image management method, and an image management program.

### BACKGROUND ART

Publishing an image on a network such as the Internet has been done by many users. A social networking service (SNS) with an image posting function is one example. Regarding the technique to publish an image, Patent Literature 1 below discloses that, when a user performs an operation to take a photograph, an image taken is automatically registered as a photograph article for a social networking service (SNS).

### CITATION LIST

### Patent Literature

PTL 1: JP 2009-212997 A

### SUMMARY OF INVENTION

### Technical Problem

Although a published image can provide various information to viewers, there is a limit to information that can be obtained from one image. For example, it is often not possible to identify ingredients from a photograph of a dish. It is also often not possible to identify each item from a photograph of an outfit of clothes and the like. If a plurality of related images are published together, viewers can obtain more information; however, it takes time and trouble for a person who publishes the image to prepare another image for that purpose.

Thus, there is a need to reduce time and trouble of a user who prepares an image to be published on the network.

### Solution to Problem

An image management device according to one aspect of the present invention includes a receiving unit configured to receive an identifier of a user intending to publish an image set including a reference image on a network from a user terminal, a search unit configured to specify one or more products corresponding to the identifier by referring to a storage unit storing a product trading history of each user and extract product images of the specified products, and a transmitting unit configured to transmit the one or more extracted product images as materials of the image set to the user terminal, the image set being generated by combining the reference image and at least some of the one or more product images.

An image management method according to one aspect of the present invention is an image management method performed by an image management device, the method including a receiving step of receiving an identifier of a user intending to publish an image set including a reference image on a network from a user terminal, a search step of specifying one or more products corresponding to the identifier by referring to a storage unit storing a product trading history of each user and then extracting product images of the specified products, and a transmitting step of transmitting the one or more extracted product images as materials of the image set to the user terminal, the image set being generated by combining the reference image and at least some of the one or more product images.

An image management program according to one aspect of the present invention causes a computer to implement a receiving unit configured to receive an identifier of a user intending to publish an image set including a reference image on a network from a user terminal, a search unit configured to specify one or more products corresponding to the identifier by referring to a storage unit storing a product trading history of each user and extract product images of the specified products, and a transmitting unit configured to transmit the one or more extracted product images as materials of the image set to the user terminal, the image set being generated by combining the reference image and at least some of the one or more product images.

According to the above aspects, images of products that have been traded in the past by a user who intends to publish an image set are extracted, and the extracted product images are transmitted to the user terminal. For the user, because the images of the products which the user already knows are automatically obtained as the materials of the image set, the time and trouble to prepare images to be published on the network are reduced.

In the image management device according to another aspect, the trading history may include a trading date, the receiving unit may further receive a generation date of the reference image, and the search unit may specify products corresponding to the identifier and whose trading date is within a specified period back from the generation date. By extracting the images of products that have been traded at the times close to the reference image generation date, the probability of extraction of the product images that are closely related to the reference image increases.

In the image management device according to another aspect, the search unit may compare an expiration date of each product with the generation date and exclude a product whose expiration date has passed at time of the generation date from those whose product images are to be extracted. By excluding the product that is less likely to be used at the time of generation of the reference image, it is possible to provide the product images that are closely related to the reference image to the user.

In the image management device according to another aspect, the search unit may set the expiration date based on text shown on a product page. In this case, there is no need to prepare the data of the expiration date separately from the product page.

In the image management device according to another aspect, the receiving unit may further receive text, and the search unit may specify products corresponding to the identifier and having product attributes corresponding to the text. By making a search using the text also, it is possible to further narrow down the product images to be extracted as materials.

In the image management device according to another aspect, the image set may be a part of an article to be published on the network, and the text may be contained in the article. In this case, because the product image that matches the content of the article is extracted, it is possible to extract the product image that is likely to be added to the image set.

In the image management device according to another aspect, the text may be contained in a web page corresponding to the reference image and selected by the user. In this case, because the product image that matches the content of the web page is extracted, it is possible to extract the product image that is likely to be added to the image set.

In the image management device according to another aspect, the search unit may further extract URL of a product page for each of the specified products, and a link for access to one or more product pages corresponding to the image set may be set based on the URL of the one or more product pages and embedded in the image set. In this case, a viewer of the published image set can easily access the product page from the image set without performing an operation for a product search.

In the image management device according to another aspect, the image set may be generated as one composite image combining the reference image and at least some of the product images, and a link to a specified portal page may be embedded in the image set, and a link to each product page may be embedded in the portal page.

In the image management device according to another aspect, the reference image and at least some of the product images may be independent of one another in the image set, and a link to the corresponding product page may be embedded in each product image of the image set.

In the image management device according to another aspect, the link embedded in the image set may be an affiliate link. In this case, it is possible to give a person who creates the image set a chance to gain a reward.

The image management device according to another aspect may further include a generation unit configured to generate the image set by combining the reference image and at least some of the one or more product images, and a publication unit configured to publish the generated image set on the network. In this case, because the generation and publication of an image set are performed in the image management device, not in the user terminal, the processing load on the user terminal can be reduced.

An image generation program according to one aspect of the present invention causes the user terminal to implement a reference image acquisition unit configured to acquire the reference image, a product image acquisition unit configured to transmit the identifier to the image management device described above and thereby acquire the one or more product images as materials of the image set, a generation unit configured to generate the image set by combining the reference image and at least some of the one or more product images, and a publication unit configured to publish the generated image set on the network. In this case, because the generation and publication of an image set are performed in the user terminal, not in the image management device, the processing load on the image management device can be reduced.

### Advantageous Effects of Invention

According to one aspect of the present invention, it is possible to reduce time and trouble of a user who prepares an image to be published on the network.

### BRIEF DESCRIPTION OF DRAWINGS

FIG. 1 is a view showing a concept of publishing images in an embodiment.

FIG. 2 is a view showing an overall configuration of an image management system according to a first embodiment.

FIGS. 3 (a) and (b) are views showing hardware configurations of a user terminal and a server, respectively, according to the first embodiment.

FIG. 4 is a block diagram showing functional configurations of the user terminal and the server according to the first embodiment.

FIG. 5 is a view showing an example of a purchase history stored in a history database.

FIG. 6 is a sequence chart showing an operation of the image management system according to the first embodiment.

FIG. 7 is a view showing configurations of a mashup application program and a server program according to the first embodiment.

FIG. 8 is a block diagram showing functional configurations of a user terminal and a server according to a second embodiment.

FIG. 9 is a sequence chart showing an operation of an image management system according to the second embodiment.

FIG. 10 is a view showing a configuration of a server program according to the second embodiment.

FIG. 11 is a view showing an example of a successful bidding history stored in a history database.

### DESCRIPTION OF EMBODIMENTS

Embodiments of the present invention are described hereinafter in detail with reference to the appended drawings. Note that, in the description of the drawings, the same or equivalent elements are denoted by the same reference symbols, and the redundant explanation thereof is omitted.

### First Embodiment

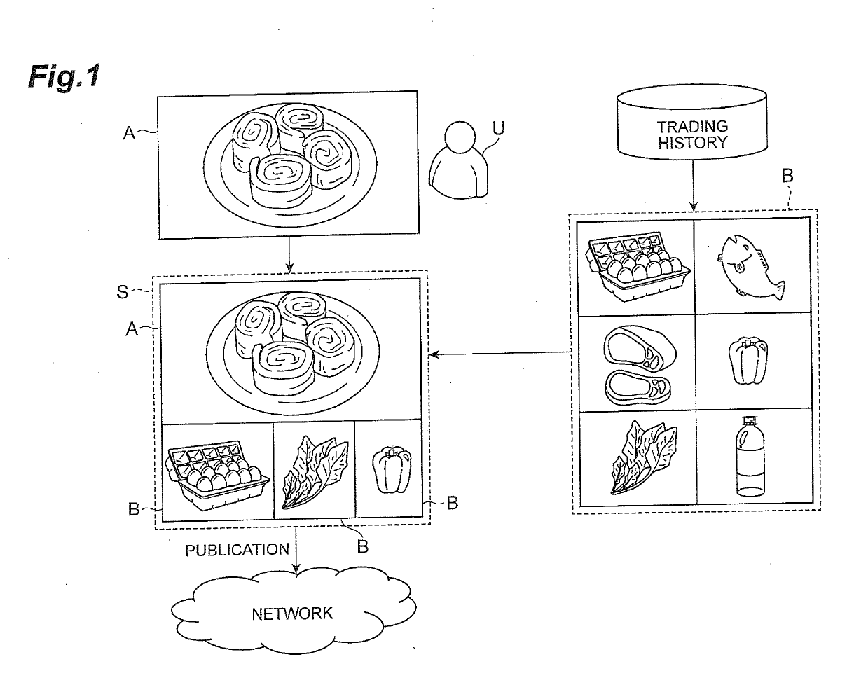

The functions and configuration of an image management system 1 according to a first embodiment are described hereinafter with reference to FIGS. 1 to 5. The image management system 1 is a computer system that assists a user in publishing an image on a network. Using the image management system 1, a user can easily prepare photographs to be published.

FIG. 1 shows a concept of publishing an image with use of the image management system 1. A user U creates an image set S by combining an image (reference image) A that is prepared by oneself and images (product images) B of products that have been traded by oneself on a network in the past, and publishes the image set S on the network.

The user U needs to prepare the reference image A by oneself. Examples of the reference image include a photograph or video taken by a digital camera or a digital video, a scanned image, computer graphics and the like, through the reference image is not limited thereto. The reference image is an image that shows the state in which a plurality of objects are used. To be specific, the reference image may be an image that shows the state in which the shapes and/or the textures of a plurality of objects have changed or an image that shows the state in which a plurality of objects are combined. For example, a photograph of a dish is one type of the reference image because it can be regarded as an image that shows the state in which the shapes and/or the textures of a plurality of ingredients have changed by cooking. Further, a photograph of an outfit of clothes and accessories is also one type of the reference image because it can be regarded as an image that shows the state in which a plurality of clothes and/or fashion accessories are combined. The object of the reference image, however, is not limited thereto as a matter of course.

The user U stores the reference image A into a terminal and runs an application program for creating the image set S. In this embodiment, the application program is referred to as “mashup application”. The mashup application acquires the images B of products that have been traded by the user U in the past and displays the product images B on the user terminal.

In this specification, “trading” means that a user obtains a product by some means. The method of obtaining a product may be purchase, auction or the like, though the way of trading is not limited thereto. Further, “product” in this specification may include not only a tangible object but also a non-tangible object such as a service.

Then, the user U combines the reference image A and one or more product images B and thereby creates the image set S. The mashup application may lay out those images to make one composite image and, in this case, the image set S is created as one file. Alternatively, the mashup application may generate a combination of images by associating those images with one another, rather than combining the reference image A and one or more product images B into one composite image. In this case, the image set S is a set of image files associated with one another.

After that, the user U publishes the image set S on the network. “Publishing the image set on the network” means uploading the image set to a specified server on the network so that a third party can view the image set. The type of the network is not limited, and it may be the Internet or an intranet. Further, the method of publication is also not limited. One way of publication is posting on an SNS or a blog, though the image set may be published in a different way from them.

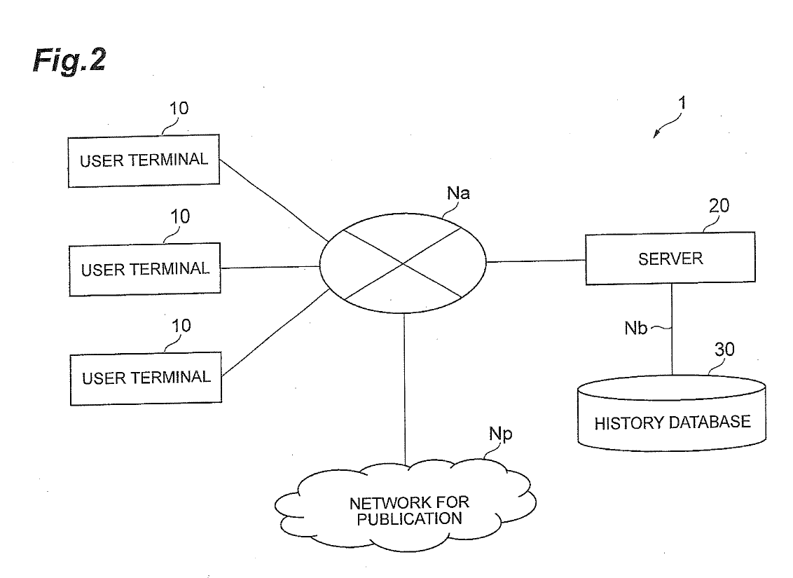

As shown in FIG. 2, the image management system 1 includes user terminals 10, a server (image management device) 20, and a history database (storage unit) 30. The user terminals 10 and the server 20 are connected through a network Na. The server 20 can access the history database 30 through a network Nb. Each of the user terminals 10 can transmit an image set to a given network Np for publication. To be specific, the network Np for publication is a server that processes data of SNSs, blogs and the like.

The variety of the user terminals 10 is not particularly limited, and it may be a stationary or portable personal computer, or a mobile terminal such as an advanced mobile phone (smart phone), a cellular phone or a personal digital assistant (PDA), for example. Although three user terminals 10 are shown in FIG. 2, the number of terminals is not particularly limited.

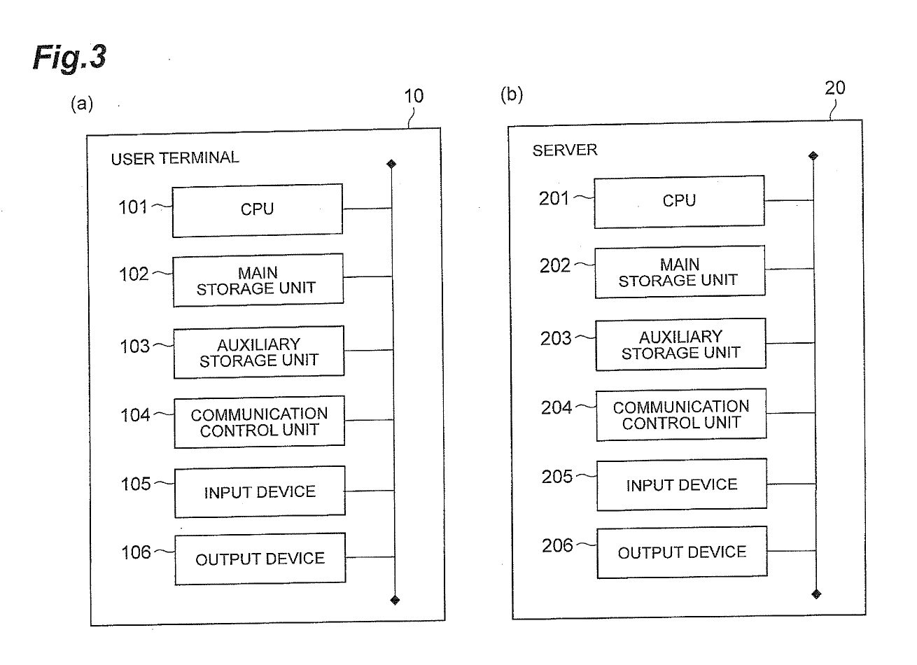

FIG. 3 shows hardware configurations of the user terminal 10 and the server 20. As shown in (a) of FIG. 3, the user terminal 10 includes a CPU 101 that executes an operating system, an application program and the like, a main storage unit 102 such as ROM and RAM, an auxiliary storage unit 103 such as a hard disk, a communication control unit 104 such as a network card or a wireless communication module, an input device 105 such as a keyboard and a mouse, and an output device 106 such as a display.

The functional elements of the user terminal 10, which are described later, are implemented by loading given software onto the CPU 101 or the main storage unit 102, making the communication control unit 104, the input device 105, the output device 106 and the like operate under control of the CPU 101, and performing reading and writing of data in the main storage unit 102 or the auxiliary storage unit 103. The data and databases required for processing are stored in the main storage unit 102 or the auxiliary storage unit 103.

As shown in (b) of FIG. 3, the server 20 also has the same hardware configuration as the user terminal 10. Note that, however, specific parts that are used for hardware resources shown in (b) of FIG. 3 can be different between the server 20 and the user terminal 10. For example, while the user terminal 10 may be provided with a touch panel as the input device 105 and the output device 106, the server 20 may be provided with a keyboard and a mouse as an input device 205 and provided with a liquid crystal monitor as an output device 206. In the server 20, as in the user terminal 10, the below-described functional elements are implemented using hardware.

Note that the server 20 may be composed of one computer or may be composed of a plurality of computers.

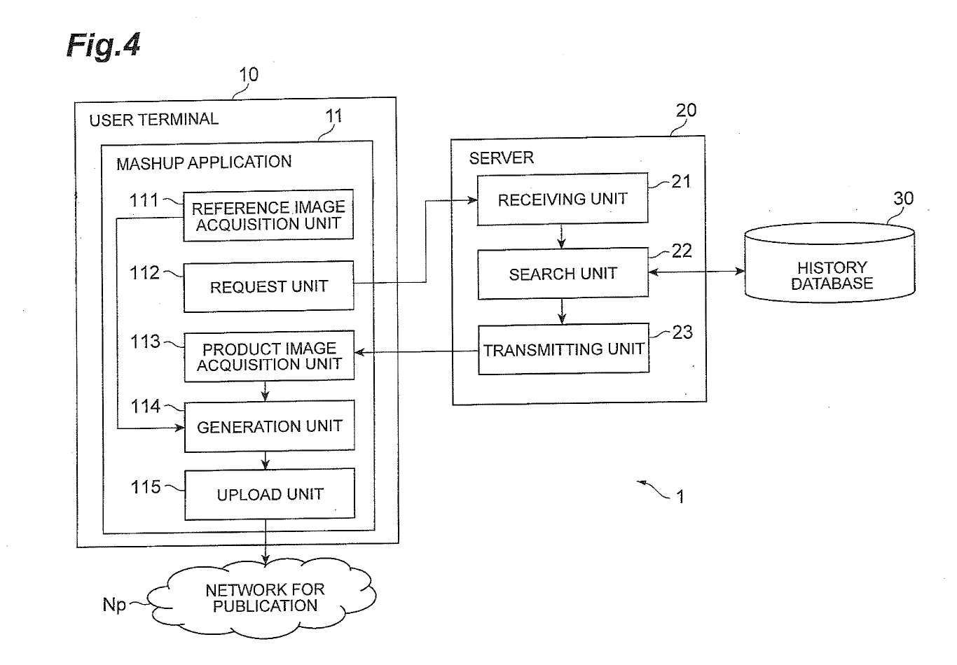

Hereinafter, the functions and the configuration of the user terminal 10 are described. As shown in FIG. 4, a mashup application 11 is installed into the user terminal 10. The mashup application 11 is an application program for controlling the generation and publication of an image set. A user can use the mashup application 11 by downloading the mashup application 11 from a specified server and installing it into the user terminal 10. Alternatively, the mashup application 11 may be installed into the user terminal 10 at the time of shipment.

The CPU 101 runs the mashup application 11 and thereby implements the functional elements such as a reference image acquisition unit 111, a request unit 112, a product image acquisition unit 113, a generation unit 114, and an upload unit (publication unit) 115. The request unit 112 is a part of the product image acquisition unit in Claims.

The reference image acquisition unit 111 is a functional element that acquires a reference image. A method of acquiring a reference image is not limited. For example, the reference image acquisition unit 111 may receive an image that is already stored in a specified folder in the user terminal 10 and selected by a user operation. Alternatively, the reference image acquisition unit 111 may immediately receive an image that is generated by a user's operation to take a photograph or operation to draw graphics. The reference image may be stored not in the user terminal 10 but in another computer on the network, and in this case also, the reference image acquisition unit 111 receives an image selected by a user operation. The reference image acquisition unit 111 outputs the reference image to the generation unit 114.

The request unit 112 is a functional element that requests images of products which a user has traded in the past to the server 20. The request unit 112 generates the search conditions for a product image and transmits the search conditions to the server 20.

The search conditions at least include an identifier of a user (which is referred to hereinafter as “user ID”). The request unit 112 may acquire the user ID that is managed and stored by the mashup application 11. Alternatively, the request unit 112 may display a specified input screen and receive the user ID that is input through the screen. Although the user ID is defined by alphabets and/or numbers in this embodiment, the user ID may be represented in any manner.

The request unit 112 may include the generation date of the acquired reference image in the search conditions. When the reference image is a photograph or a video, the date when they were taken is the generation date of the reference image. When the reference image is computer graphics, the date when they were created or updated is the generation date of the reference image. The request unit 112 acquires the generation date by referring to attribute information (for example, the file creation date and time) that is recorded for the reference image.

The request unit 112 may include text to be used for search in the search conditions. For example, when an image set is to be published as a part of a posted article, the request unit 112 may acquire the text (for example, the title, body, comments and the like) of the article entered by a user as the search conditions. Alternatively, the request unit 112 may make an inquiry to a user about a web page corresponding to the reference image and acquire the text on the web page specified by the user in response to the inquiry. For example, when the reference image is a photograph of a dish, the request unit 112 makes an inquiry to a user about a web page on which the recipe of the dish is available and acquires the text on the web page specified by the user. Alternatively, the request unit 112 may display a specified input screen and acquire the conditions (for example, the range of trading dates, product name, product category and the like) entered on the screen.

The product image acquisition unit 113 is a functional element that receives data of one or more product images transmitted from the server 20 according to the search conditions and outputs the data to the generation unit 114.

The generation unit 114 is a functional element that generates an image set from the reference image and product images. The generation unit 114 displays one or more input product images on the screen and further displays a user interface for selecting at least some of the product images on the screen. The user interface may have the function of narrowing down the plurality of displayed product images based on product attributes (for example, a product category) or the like.

After a user selects product images, the generation unit 114 generates an image set that includes the selected product images and the input reference image. The generation unit 114 may generate an image set by laying out those images to make one composite image and, in this case, the image set is created as one file. Alternatively, the generation unit 114 may generate an image set by simply associating those images, and in this case, the image set is a set of image files associated with one another.

As described in detail later, URL (Uniform Resource Locator) of a product page is associated with each of the received product images. The generation unit 114 sets up a link based on the URL and embeds the link in the image set.

In the case where the image set is one composite image, the generation unit 114 generates a link to a portal page for accessing each product page based on the URLs of the web pages of the products indicated by the image set. The generation unit 114 then embeds the link in the image set. The portal page is a web page in which a link to each product page corresponding to the image set is embedded. In this case, a third party can access the portal page by clicking on the image set and further access each product page (specifically, the web page of each product indicated by the image set) through the portal page.

On the other hand, in the case where the image set is a plurality of images simply associated with one another, the generation unit 114 embeds a link to the corresponding product page in each product image. In this case, a third party can directly access the product page corresponding to the product image that is clicked on.

The generation unit 114 may generate a plurality of candidates for the image set and display them on the screen, and finally acquire the image set selected by a user. In this case, the generation unit 114 generates a plurality of patterns of candidates from the input reference image and the product images and displays them on the screen, and further displays a user interface for selecting one image set on the same screen. Then, the generation unit 114 stores the image set that is selected by a user.

For example, it is assumed that the reference image A and five product images B1 to B3 are obtained, and an image set can include up to three product images. In this case, the generation unit 114 generates seven candidate patterns for the image set, which are (A,B1), (A,B2), (A,B3), (A,B1,B2), (A,B1,B3), (A,B2,B3) and (A,B1,B2,B3), and presents them to the user.

As described above, a method of prompting a user to select an image set is not limited, and in any case, the generation unit 114 outputs the image set including the product images selected by the user to the upload unit 115.

The upload unit 115 is a functional element that transmits the image set to a server (not shown) on the network Np for publication. Because the way of publication is not limited as described above, the image set may be transmitted to an SNS management server, a blog management server, or another type of server.

The functions and configuration of the server 20 are described hereinafter. As shown in FIG. 4, the server 20 includes a receiving unit 21, a search unit 22, and a transmitting unit 23 as functional elements.

The receiving unit 21 is a functional element that receives the search conditions transmitted from the user terminal 10. As described above, the search conditions at least include a user ID and, in some cases, further include the generation date of the reference image and/or the text. The receiving unit 21 outputs the search conditions to the search unit 22.

The search unit 22 is a functional element that specifies one or more products corresponding to the user ID by referring to the history database 30 and extracts the image of each of the specified products. Because the history database 30 stores the product trading history of each user, the search unit 22 can specify the products which a user has traded in the past by referring to the database. Although the type of trading is not limited as described above, it is assumed in this embodiment that the history database 30 stores a purchase history.

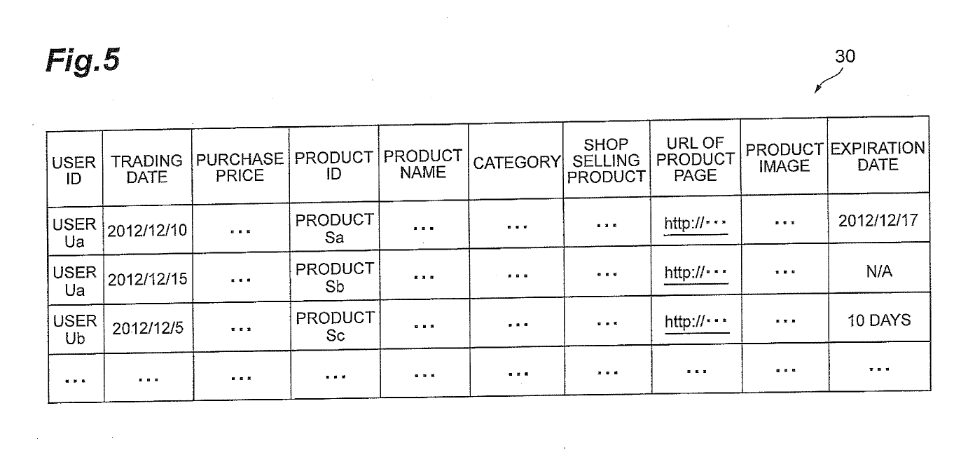

The purchase history is data indicating the history of products which a user has purchased by online shopping. The purchase history includes a user ID and an identifier of a product (product ID), and those IDs are associated with each other. The purchase history further includes the product trading date, and an arbitrary date may be set as the trading date. For example, it may be the date when a user performs a purchase procedure (purchase date), the date when a shop ships a product (shipping date), or the date when a user actually receives a product (received date). In FIG. 5, a purchase price is also shown as the attributes of trading.

It is possible to specify the attributes of a product from the purchase history. In FIG. 5, a product name, a product category, a shop selling the product, URL of a product page, product image data, and an expiration date are shown as one example of the product attributes. Note that the expiration date may be indicated by a use-by date or a best-before date, may be indicated by an available period, or may be set based on another standard.

The configuration of the purchase history is not limited to the example of FIG. 5. For example, some of the product attributes shown therein may be omitted, or other items may be included as the product attributes in the purchase history. Further, the purchase history shown in FIG. 5 may be normalized or made redundant by an arbitrary policy. For example, the database may be constructed so that the product attributes are read from a product table (not shown) through a product ID.

The search unit 22 searches the purchase history by using the entered search conditions and extracts the images of products which a user has traded in the past. A search method is not limited to one, and various methods may be used as described below.

[Search by User ID Only]

The search unit 22 may search the history database 30 by using the user ID only and thereby acquire the product images corresponding to the ID. In the case where the search unit 22 makes a search in the purchase history shown in FIG. 5 with the user ID “user Ua”, the search unit 22 acquires two products images of the products Sa and Sb.

[Search by User ID and Period]

The search unit 22 may specify the products which correspond to the user ID and whose trading date is within a specified period and acquire the image of each of the specified products. For example, in the case where the search unit 22 makes a search in the purchase history shown in FIG. 5 by using the user ID “user Ua”, the reference image generation date “Dec. 20, 2012”, and the search range “the period of seven days back from the reference image generation date” that is specified by the user or automatically set by the server 20, the product Sb is extracted while the product Sa is not extracted.

The search range for the trading date in this search may be set in any manner. For example, the search unit 22 may set the period that is specified by a user as the search range. Alternatively, the search unit 22 may set the period of a specified number of days (for example, two weeks) back from the reference image generation date as the search range. By extracting the images of products that have been traded at the times close to the reference image generation date, the probability of extraction of the product images that are closely related to the reference image increases.

[Search in Consideration of Expiration Date]

The search unit 22 may specify the products which correspond to the user ID, whose trading date is within a specified period and whose expiration date has not passed at the time of generation of the reference image, and then acquire the image of each of the specified products.

For example, it is assumed that the search unit 22 makes a search in the purchase history shown in FIG. 5 by using the user ID “user Ua”, the reference image generation date “Dec. 20, 2012”, the search range “the period of fifteen days back from the reference image generation date”, and the expiration date conditions. In this case, while the product Sb which is available at the time of the reference image generation date (Dec. 20, 2012) is extracted, the product Sa whose expiration date has passed at the time of the date is excluded. If, however, the reference image generation date is “Dec. 16, 2012”, not “Dec. 20, 2012”, both of the products Sa and Sb are extracted. A product for which the expiration date is not set, such as the product Sb, always satisfies the expiration date conditions.

By excluding the product that is less likely to be used at the time of generation of the reference image in consideration of the expiration date, it is possible to provide the product images that are closely related to the reference image to the user.

When the expiration date is explicitly stored as one item of the product attributes as shown in FIG. 5, the search unit 22 can simply refer to that item.

When, on the other hand, the expiration date is not explicitly stored as the product attributes, the search unit 22 may extract the text indicating the expiration date from the data of the product page and set the expiration date based on the text. In this case, there is no need to prepare the data of the expiration date separately from the product page.

For example, when the web page of a certain product contains the description that “the best-before date is 30 days”, the search unit 22 sets the expiration date of the product to 30 days. For another example, when the product page contains a keyword related to storage of a product such as “frozen” or “cold”, the search unit 22 may set the expiration date corresponding to the keyword based on preset rules. For example, the search unit 22 sets the expiration date to one month for the product whose product page contains the keyword “frozen” and sets the expiration date to one week for the product whose product page contains the keyword “cold”.

For products whose expiration date is often not explicitly shown such as vegetables, on the assumption that a database that stores the expiration date which is set for each product category or product type is prepared on the server, the expiration date of a product may be set by reference to the database. In this case, the search unit 22 acquires the expiration date of a product by accessing the database.

[Use of Text]

In each of the above-described search methods, the search unit 22 may acquire the images of products that further satisfy the condition that the product attributes correspond to the text indicated by the search conditions. By making a search using the text also, it is possible to further narrow down the product images. When the text is a part of a posted article, because the product image that matches the content of the article is extracted, it is possible to extract the product image that is likely to be added to the image set. When the text is on a web page, because the product image that matches the content of the web page is extracted, it is possible to extract the product image that is likely to be added to the image set.

When comparing the text with the product attributes, the search unit 22 may extract a keyword for a search from the text by using known natural language processing. For example, the search unit 22 may extract the keyword “mackerel” from the text “mackerel simmered in miso” and read the image of the product corresponding to this keyword and the user ID from the history database 30.

As described above, the search unit 22 acquires product images by using various methods. After that, the search unit 22 associates each of the extracted product images with the URL of the corresponding product page. The URL can be acquired from the history database 30. For example, the search unit 22 associates the image of the product Sa with the URL of the web page of the product Sa, and associates the image of the product Sb with the URL of the web page of the product Sb. Then, the search unit 22 outputs the product images with which the URL of the product page is associated to the transmitting unit 23.

The transmitting unit 23 is a functional element that transmits the extracted product images as materials of the image set to the user terminal 10. As described above, the transmitted product images are processed by the mashup application 11.

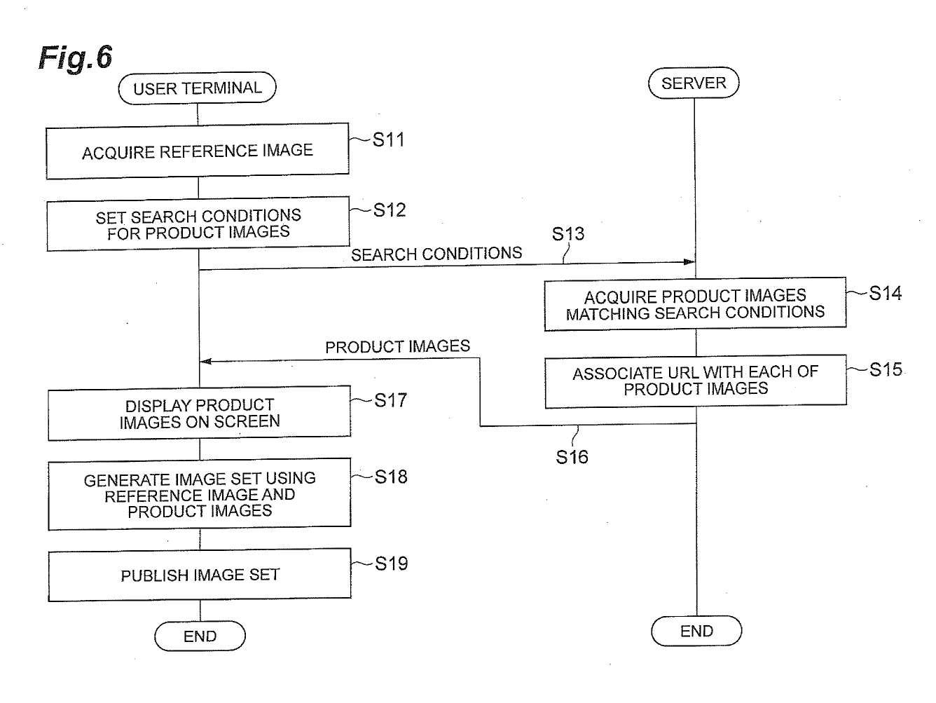

Hereinafter, the operation of the image management system 1 and an image management method according to this embodiment are described with reference to FIG. 6.

First, in the user terminal 10, the reference image acquisition unit 111 acquires a reference image based on a user operation (Step S11), and the request unit 112 sets search conditions for product images (Step 512) and transmits the search conditions to the server 20 (Step S13). As described earlier, the search conditions at least include a user ID and, in some cases further include a reference image generation date and/or text.

In the server 20, the receiving unit 21 receives the search conditions (Step S13, receiving step), and the search unit 22 refers to the history database 30 by using the search conditions and thereby acquires the product images that match the conditions (Step S14, search step). The search unit 22 then associates URL with each of the product images (Step S15). After one or more product images are prepared, the transmitting unit 23 transmits the product images to the user terminal 10 (Step S16, transmitting step).

In the user terminal 10, the product image acquisition unit 113 receives the product images and displays them on a screen (Step S17). Then, the generation unit 114 generates an image set using the reference image and at least one product images based on a user operation (Step S18), and the upload unit 115 transmits the image set to the network Np for publication to publish the image set (Step S19). Note that, when the image set is a part of a posted article, the whole article is uploaded to the network Np.

A third party can access the published image set. Because a link to a portal page or each product page is embedded in the image set, a viewer can easily access the product page from the image set without performing an operation for a product search.

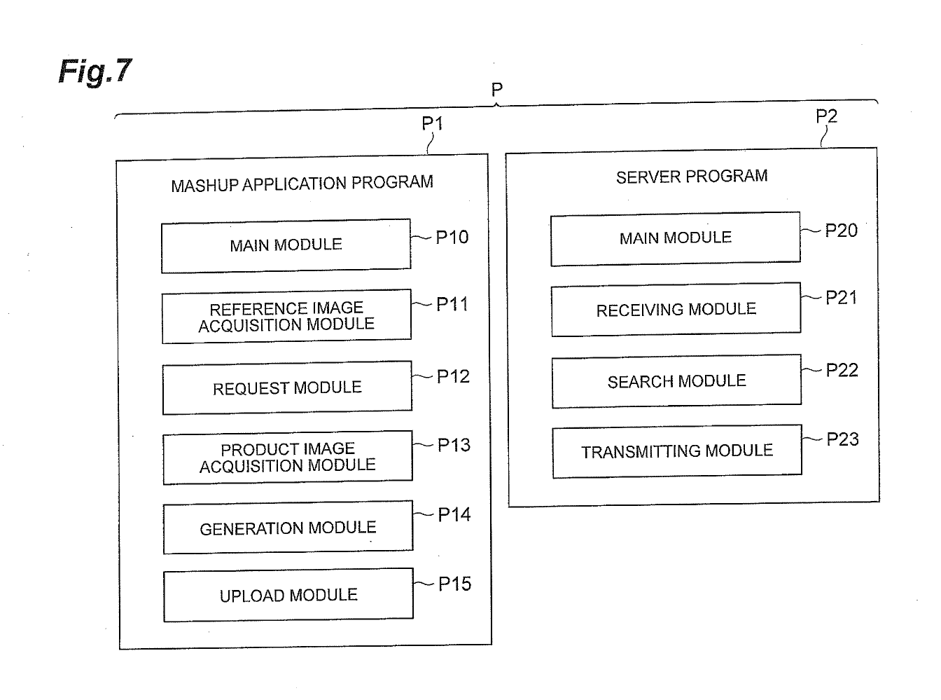

A program P for implementing the image management system 1 is described hereinafter with reference to FIG. 7. The program P includes a mashup application program (image generation program) P1 that causes a computer to function as the user terminal 10 and a server program (image management program) P2 that causes a computer to function as the server 20.

The mashup application program P1 includes a main module P10, reference image acquisition module P11, a request module P12, a product image acquisition module P13, a generation module P14, and an upload module P15.

The main module P10 is a part that exercises control over the generation of an image set in the user terminal 10. The functions implemented by executing the reference image acquisition module P11, the request module P12, the product image acquisition module P13, the generation module P14 and the upload module P15 are equal to the functions of the reference image acquisition unit 111, the request unit 112, the product image acquisition unit 113, the generation unit 114 and the upload unit 115 described above, respectively.

The server program P2 includes a main module P20, a receiving module P21, a search module P22, and a transmitting module P23.

The main module P20 is a part that exercises control over the image management function in the server 20. The functions implemented by executing the receiving module P21, the search module P22 and the transmitting module P23 are equal to the functions of the receiving unit 21, the search unit 22 and the transmitting unit 23 described above, respectively.

The mashup application program P1 and the server program P2 are provided in the form of being recorded in a static manner on a tangible recording medium such as CD-ROM or DVD-ROM or semiconductor memory, for example. Further, the programs P1 and P2 may be provided as a data signal superimposed onto a carrier wave through a communication network.

As described above, according to this embodiment, images of products that have been traded in the past by a user who intends to publish an image set are extracted, and the extracted product images are transmitted to the user terminal 10. For the user, because the images of the products which the user already knows are automatically obtained as the materials of the image set, the time and trouble to prepare images to be published on the network Np are reduced. The publication of the image set is thereby promoted.

For example, in the case a user who has made a dish using the ingredients purchased by online shopping takes a photograph of the dish and publishes it, the photographs of the ingredients (product images) are displayed on the user terminal 10 based on the purchase history of the user. Thus, the user can create an image set by combining the photograph of the dish taken by oneself with the photographs of the ingredients presented automatically and publish the image set on the network Np without need to prepare the photographs of the ingredients by oneself.

For another example, in the case where a user takes a photograph of an outfit of clothes and accessories purchased by online shopping and publishes it, the photographs of the respective clothes and accessories (product images) are displayed on the user terminal 10 based on the purchase history of the user. Thus, the user can create an image set by combining the photograph of the outfit taken by oneself with the photographs of the clothes and accessories presented automatically and publish the image set on the network Np without need to prepare the photographs of the respective clothes and accessories by oneself.

In this embodiment, because the generation and publication of an image set are performed in the user terminal 10, not in the server 20, the processing load on the server 20 can be reduced.

### Second Embodiment

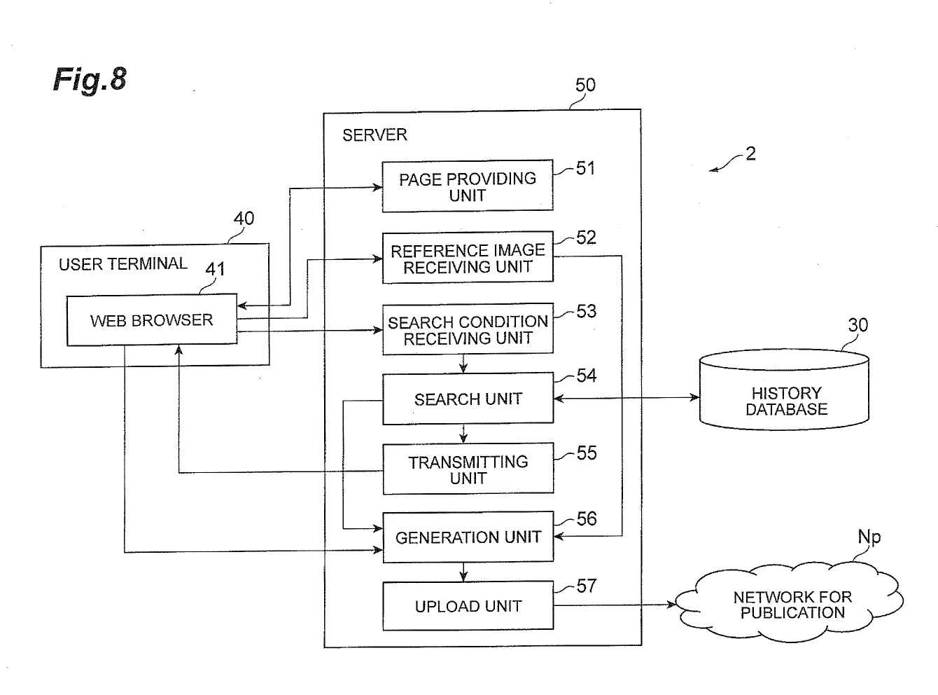

The functions and configuration of an image management system 2 according to a second embodiment are described hereinafter with reference to FIG. 8. The image management system 2 includes user terminals 40, a server (image management device) 50, and a history database 30. In this embodiment, a mashup application is not installed into the user terminal 40, and a user performs an operation to publish an image set on a web browser 41. The user terminal 40 mainly performs display of a screen and receiving of data input only, and the processing of actually generating an image set is performed in the server 50. Differences from the first embodiment are particularly described hereinbelow.

The server 50 includes a page providing unit 51, a reference image receiving unit 52, a search condition receiving unit 53, a search unit 54, a transmitting unit 55, a generation unit 56, and an upload unit 57 as functional elements.

The page providing unit 51 is a functional element that provides a web page for receiving operations necessary for publishing an image set to the user terminal 40. When a user performs an operation to access the web page on the web browser 41, the web browser 41 transmits a request containing the URL of the page to the server 50. In response to the request, the page providing unit 51 generates a web page and transmits the web page to the user terminal 40. The web page for publishing an image set is thereby displayed on the web browser 41.

The reference image receiving unit 52 is a functional element that receives data of a reference image from the user terminal 40. When a user indicates the upload of a reference image through the web browser 41, the user terminal 40 transmits data of the reference image to the server 50. The reference image receiving unit 52 outputs the received data to the generation unit 56.

The search condition receiving unit 53 is a functional element that receives search conditions for product images from the user terminal 40. The search condition receiving unit 53 outputs the received search conditions to the search unit 54. The search condition receiving unit 53 at least receives a user ID, and this identifier may be entered by a user on the web browser 41, or the web browser 41 may automatically read the identifier from HTTP cookie.

In the case of using a reference image generation date as one of the search conditions, the search condition receiving unit 53 may specify the generation date from attribute information (for example, file creation date and time) that is recorded for the reference image received by the reference image receiving unit 52. In the case where a user performs an operation to enter and transmit text as one of the search conditions on the web browser 41, the user terminal 40 transmits the text to the server 50, and the search condition receiving unit 53 receives the text also as one of the search conditions.

The search unit 54 is a functional element that extracts one or more product images corresponding to a user ID by referring to the history database 30. The transmitting unit 55 is a functional element that transmits the extracted product images as materials of the image set to the user terminal 40. The two elements are the same as those in the first embodiment, and therefore the detailed description thereof is omitted.

The generation unit 56 is a functional element that generates an image set from the reference image and product images. When a user specifies product images on the web browser 41, the user terminal 40 transmits information of the product images to the server 50. The generation unit 56 generates an image set based on the information and the reference image input from the reference image receiving unit 52 and then outputs the image set to the upload unit 57.

The generation unit 56 may generate the image set by laying out those images to make one composite image or may generate the image set by simply associating those images, as in the first embodiment. A link is also embedded in the same manner as in the first embodiment.

The upload unit 57 is a functional element that transmits the image set to a server on the network Np for publication (which is the same as in the first embodiment).

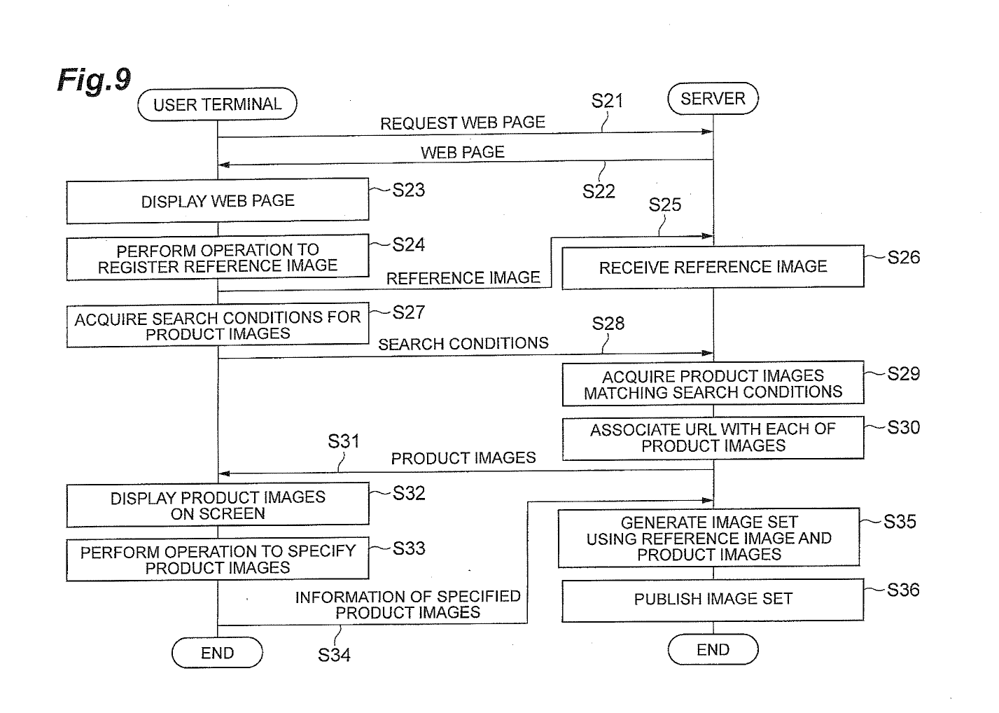

Hereinafter, the operation of the image management system 2 and an image management method according to this embodiment are described with reference to FIG. 9.

First, in the user terminal 40, the web browser 41 requests a web page for image set publication to the server 50 based on a user operation (Step S21). In the server 50, the page providing unit 51 transmits a specified web page to the user terminal 40 in response to the request (Step S22). In the user terminal 40, the web browser 41 receives and displays the web page (Step S23).

After that, when the user performs an operation to register the reference image on the web browser 41 (Step S24), the web browser 41 transmits the reference image to the server 50 (Step S25), and the reference image receiving unit 52 receives the image (Step S26). Further, the web browser 41 acquires search conditions for product images (Step S27) and transmits the conditions to the server 50 (Step S28). The search conditions at least include a user ID and, in some cases, further include text entered by the user.

In the server 50, the search condition receiving unit 53 receives the search conditions (Step S28, receiving step). Then, the search unit 54 refers to the history database 30 by using the search conditions and thereby acquires product images that match the conditions (Step S29, search step), and then associates URL with each of the product images (Step S30). After one or more product images are prepared, the transmitting unit 55 transmits the product images to the user terminal 40 (Step S31, transmitting step).

In the user terminal 40, the web browser 41 receives the product images and displays them on the screen (Step S32). After that, when a user performs an operation to specify product images on the web browser 41 (Step S33), the user terminal 40 transmits information of the specified product images to the server 50 (Step S34).

In the server 50, the generation unit 56 generates an image set using the reference image and at least one product images based on the information (Step S35). Then, the upload unit 57 transmits the image set to the network Np for publication to publish the image set (Step S36). Note that, in this embodiment also, when the image set is a part of a posted article, text, which is a part of the article, is also transmitted from the user terminal 40 to the server 50, and the server 50 uploads the article containing the text and the image set to the network Np for publication.

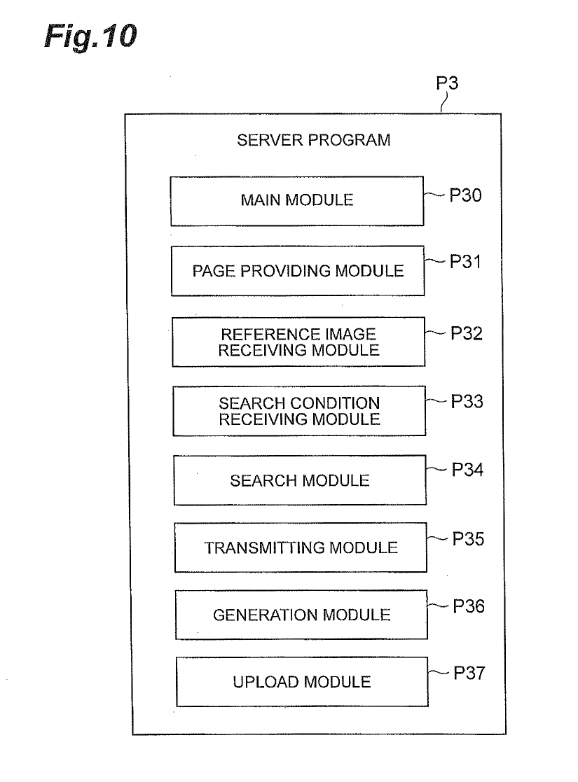

A server program (image management program) P3 that causes a computer to function as the server 50 is described hereinafter with reference to FIG. 10.

The server program P3 includes a main module P30, a page providing module P31, a reference image receiving module P32, a search condition receiving module P33, a search module P34, a transmitting module P35, a generation module P36, and an upload module P37.

The main module P30 is a part that exercises control over the image management function in the server 50. The functions implemented by executing the page providing module P31, the reference image receiving module P32, the search condition receiving module P33, the search module P34, the transmitting module P35, the generation module P36 and the upload module P37 are equal to the functions of the page providing unit 51, the reference image receiving unit 52, the search condition receiving unit 53, the search unit 54, the transmitting unit 55, the generation unit 56 and the upload unit 57 described above, respectively.

The server program P3 can be distributed in the same manner as the server program P2 in the first embodiment.

In the second embodiment, the same advantageous effects as in the first embodiment can be obtained. In addition, in this embodiment, there is no need to distribute a mashup application, and a user can create an image set as long as the user terminal 40 has the web browser 41. Further, because the generation and publication of an image set are performed in the server 50, not in the user terminal 40, the processing load on the user terminal 40 can be reduced.

An embodiment of the present invention is described in detail above. However, the present invention is not limited to the above-described embodiment. Various changes and modifications may be made to the present invention without departing from the scope of the invention.

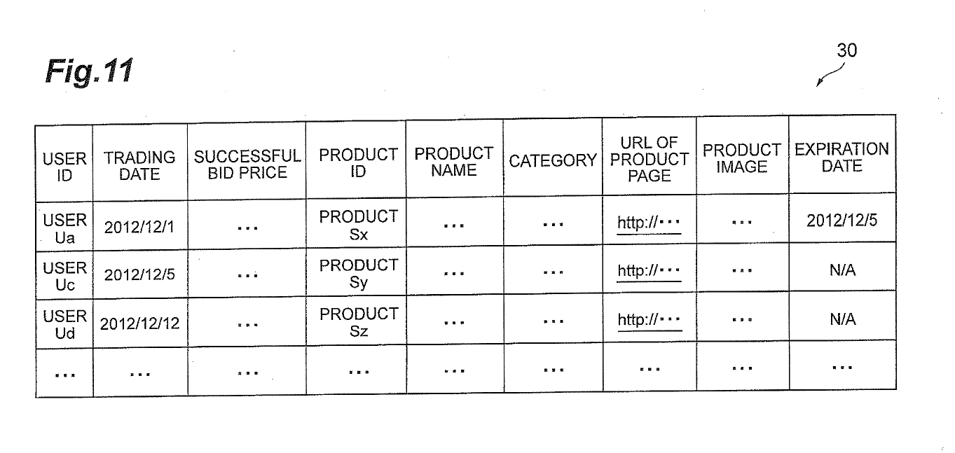

Although the history database 30 stores the purchase history in the above-described embodiments, the type of the trading history is not particularly limited as described above. For example, the history database 30 may store the successful bidding history shown in FIG. 11, and the search unit may extract product images from the successful bidding history.

The successful bidding history is data indicating the history of products which a user has made a successful bid and obtained by an Internet auction. The successful bidding history also includes a user ID and an identifier of a product (product ID), and those IDs are associated with each other. The trading date in the successful bidding history may be the date when a user makes a successful bid (bidding date), the date when a seller ships a product (shipping date), the date when a user actually receives a product (received date), or the date when another action is done. In FIG. 11, a successful bid price is also shown as the attributes of trading.

It is possible to specify the attributes of a product from the successful bidding history as well. In FIG. 11, a product name, a product category, URL of a product page (a page on which a product is on auction or on sale), product image data, and an expiration date are shown as one example of the product attributes.

Like the purchase history, the configuration of the trading history is not limited to the example of FIG. 11, and the product attributes can be selected in an arbitrary manner, and may be normalized or made redundant by an arbitrary policy. The history database (trading history) 30 may have any configuration as long as the product attributes (at least product images) can be obtained through a user ID.

Although an image set contains a link to a product page in the above-described embodiments, embedding of a link may be omitted.

Alternatively, URL of an affiliate link, instead of URL of a product page, may be embedded in an image set. An affiliate link can be generated by a known method using a user ID (affiliate ID). In this case, when a third party clicks on a product image in an image set, it is possible to access the corresponding product page, and when the third party purchases a product on the product page, a reward is granted to a person who creates the image set.

In the case where a product image cannot be obtained at the time of searching for product images due to frequent turnover of products, the search unit may acquire an image of a similar product by searching the product database with use of a product category or the like.

The mashup application may be software exclusive to a specific product category. For example, the mashup application may be an application exclusive to image sets of dishes or an application exclusive to image sets of outfits of clothes and accessories. In this case, a specific product category is always included in the search conditions.

When the reference image is related to an outfits of clothes and accessories, the search unit may estimate season from the reference image generation date and extract, from the history database 30, images of products which a user has purchased during the season. Alternatively, the search unit may analyze the reference image and extract a dominant color and then extract images of products with that color from the history database 30.

### REFERENCE SIGNS LIST

1,2 . . . image management system, 10,40 . . . user terminal, 11 . . . mashup application, 20,50 . . . server (image management device), 21 . . . receiving unit, 22 . . . search unit, 23 . . . transmitting unit, 30 . . . history database (storage unit), 41 . . . web browser, 51 . . . page providing unit, 52 . . . reference image receiving unit, 53 . . . search condition receiving unit, 54 . . . search unit, 55 . . . transmitting unit, 56 . . . generation unit, 57 . . . upload unit (publication unit), 111 . . . reference image acquisition unit, 112 . . . request unit, 113 . . . product image acquisition unit, 114 . . . generation unit, 115 . . . upload unit (publication unit), P1 . . . mashup application program (image generation program), P10 . . . main module, P11 . . . reference image acquisition module, P12 . . . request module, P13 . . . product image acquisition module, P14 . . . generation module, P15 . . . upload module, P2,P3 . . . server program (image management program), P20 . . . main module, P21 . . . receiving module, P22 . . . search module, P23 . . . transmitting module, P30 . . . main module, P31 . . . page providing module, P32 . . . reference image receiving module, P33 . . . search condition receiving module, P34, . . . search module, P35 . . . transmitting module, P36 . . . generation module, P37 . . . upload module

1. An image management device comprising:
at least one memory operable to store program instructions;
at least one processor operable to access said memory and read and carry out said instructions, said instructions including:
receiving instructions configured to cause at least one of said at least one processors to receive from a user terminal a user identifier of a user intending to publish an image set including a reference image on a network, and a related information of the reference image, the related information including at least one of a generation date of the reference image, a related text associated with the reference image by the user, and a color of the reference image;
search instructions configured to cause at least one of said at least one processors to specify one or more products corresponding to both of the user identifier and the related information by referring to a storage unit storing a product trading history of each user and extract product images of the specified products; and
transmitting instructions configured to cause at least one of said at least one processors to transmit the one or more extracted product images as materials of the image set to the user terminal, the image set being generated by combining the reference image and at least some of the one or more product images.

2. The image management device according to claim 1, wherein
the trading history includes a trading date,
the related information includes the generation date, and
the search instructions are further configured to cause at least one of said at least one processors to specify products corresponding to the identifier and whose trading date is within a specified period back from the generation date.

3. The image management device according to claim 2, wherein
the search instructions are further configured to cause at least one of said at least one processors to compare an expiration date of each product with the generation date and exclude a product whose expiration date has passed at time of the generation date from those whose product images are to be extracted.

4. The image management device according to claim 3, wherein
the search instructions are further configured to cause at least one of said at least one processors to set the expiration date based on text shown on a product page.

5. The image management device according to claim 1, wherein
the related information includes the related text, and
the search instructions are further configured to cause at least one of said at least one processors to specify products corresponding to the user identifier and having product attributes corresponding to the related text.

6. The image management device according to claim 5, wherein
the related text is a text of an article to be posted together with the reference image.

7. The image management device according to claim 5, wherein
the related text is a text in a web page corresponding to the reference image and selected by the user.

8. The image management device according to claim 1, wherein
the search instructions are further configured to cause at least one of said at least one processors to extract a URL of a product page for each of the specified products, and
a link for access to one or more product pages corresponding to the image set is set based on the URL of the one or more product pages and embedded in the image set.

9. The image management device according to claim 8, wherein
the image set is generated as one composite image combining the reference image and at least some of the product images, and
a link to a specified portal page is embedded in the image set, and a link to each product page is embedded in the portal page.

10. The image management device according to claim 8, wherein
the reference image and at least some of the product images are independent of one another in the image set, and
a link to the corresponding product page is embedded in each product image of the image set.

11. The image management device according to claim 8, wherein
the link embedded in the image set is an affiliate link.

12. The image management device according to claim 1, further comprising:
generation instructions configured to cause at least one of said at least one processors to generate the image set by combining the reference image and at least some of the one or more product images; and
publication instructions configured to cause at least one of said at least one processors to publish the generated image set on the network.

13. An image generation program causing the user terminal to implement:
reference image acquisition instructions configured to cause at least one of said at least one processors to acquire the reference image;
product image acquisition instructions configured to cause at least one of said at least one processors to transmit the user identifier and the related information of the reference image to the image management device according to claim 1 and thereby acquire the one or more product images as materials of the image set;
generation instructions configured to cause at least one of said at least one processors to generate the image set by combining the reference image and at least some of the one or more product images; and
publication instructions configured to cause at least one of said at least one processors to publish the generated image set on the network.

14. An image management method performed by at least one processor in an image management device, comprising:
receiving from a user terminal a user identifier of a user intending to publish an image set including a reference image on a network, and a related information of the reference image, the related information including at least one of a generation date of the reference image, a related text associated with the reference image by the user, and a color of the reference image;
specifying one or more products corresponding to both of the user identifier and the related information by referring to a storage unit storing a product trading history of each user and then extracting product images of the specified products; and
transmitting the one or more extracted product images as materials of the image set to the user terminal, the image set being generated by combining the reference image and at least some of the one or more product images.

15. A non-transitory computer readable medium storing an image management program causing a computer to:
receive from a user terminal a user identifier of a user intending to publish an image set including a reference image on a network, and a related information of the reference image, the related information including at least one of a generation date of the reference image, a related text associated with the reference image by the user, and a color of the reference image;
specify one or more products corresponding to both of the user identifier and the related information by referring to a storage unit storing a product trading history of each user and extract product images of the specified products; and
transmit the one or more extracted product images as materials of the image set to the user terminal, the image set being generated by combining the reference image and at least some of the one or more product images.
